(19) United States
(12) Patent Application Publication
(10) Pub. No.: US 2004/0250945 A1
(43) Pub. Date: Dec. 16, 2004

(54) Method for and apparatus for bonding patterned imprint to a substrate by adhering means

(75) Inventors: Rui-Ting Zheng, Taipei City (TW); Hsi-Hsiang Lin, Yilan County (TW); Hung-Yin Tsai, Hsinchu County (TW); Chien-Chang Su, Kaohsiung City (TW); Chien-Yang Chen, Hsinchu County (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/671,531

(22) Filed: Sep. 29, 2003

(30) Foreign Application Priority Data
Jun. 10, 2003 (TW) 092115663

(51) Int. Cl. B44C 1/165; B44C 1/00

(52) U.S. Cl. 156/230; 156/232

(57) ABSTRACT

A method for bonding patterned imprint by transferring is disclosed, which comprises the following steps: (a) providing a first module having a molding substrate, a molding layer and a patterned molding features, and a second module having a substrate; wherein said molding layer and said patterned molding features are located on said molding substrate; (b) coating a release layer on said molding features; (c) filling a transfer layer into the recess which is located between the patterned molding features; (d) coating an adhesion layer on said substrate of said second module; (e) combining and contacting said second module and said first module together for transferring said transfer layer to said substrate of said second module; and (f) separating said second module from said first module.

### BACKGROUND OF THE INVENTION

1. Field of the Invention

The present invention relates to a method for bonding and transferring patterned imprint by, and more particularly, to a method and apparatus for fabricating integrated circuits and various nano-devices through bonding and transferring imprints.

2. Description of Related Art

It is known that the conventional photolithography used for manufacturing integrated circuit have to achieve several complicate steps subsequently. These complicate steps include coating photoresist, pre-baking, exposure, post-baking, etching and developing. For performing these subsequent steps in the photolithography, a plurality of expensive machines (e.g. a Deep UV Scanner, etc.) is required. In conventional photolithography, the minimum width of lines on the chips are frequently achieved or controlled by a Deep UV Scanner. However, owing to the limit of the wavelength of the light used in the Deep-UV Scanner, it is very difficult to form a line having a width in nanoscale order (i.e. <100 nm).

Currently, most of the chips having line width in nanoscale order are achieved through “Nanoimprint Lithography” or “Step and Flash Imprint Lithography⇄. Both of them can massively produce chips having nanoscale width imprint. However, they also suffer some serious drawbacks. Taking nanoimprint lithography method for example, high temperature and high pressure are required in this method. The substrate will be distorted owing to thermal expansion when it is heated. Also, the precision of the line width of the imprint is badly affected. On the other hand, the materials that can be applied for step and flash imprint lithography method and their sources are seriously limited. Therefore, the application of the step and flash imprint lithography method is not popular. Moreover, since etching is required in both “Nanoimprint Lithography” and “Step and Flash Imprint Lithography”, the procedure of these two methods for forming final patterns in nanoscale is inevitably complicate.

The method of imprint lithography was disclosed in U.S. Pat. No. 5,772,905, which teached that a mold having at least one protruding feature was firstly pressed into a film on a substrate, and then the patterns in the mold were replaced in the film after the mold was removed from the film. However, it was a complicated step to pressed the mold into the film because a sufficiently high molding pressure was needed to transfer the mold pattern to the film, which might need some thermal treatment to become softening simultaneously. The pressure and heating temperature must be precisely controlled, which was not easy to achieve. Besides, the thin film in the recess was removed by etching process, which made the method of imprint lithography more complicated.

The method of step and flash imprint lithography was disclosed in U.S. Pat. No. 6,334,960. The method disclosed in U.S. Pat. No. 6,334,960 is shown in FIG. 7(a) to 7(e). The procedure is achieved first by making the transfer layer 720 on the substrate 710 contacts with a mold 730 having a relief structure formed therein, as shown in FIG. 7(a). Then, a solution of photo-curable polymer composition 740 is poured for filling the interspaces of the relief structures in the mold 730, as shown in FIG. 7(b). The photo-curable polymer composition 740 is cured through UV exposure and further form a solidified polymeric material 750 on the transfer layer 720. The transfer layer 720 and the solidified polymeric material 750 are then subjected to an environment such that the transfer layer 720 is selectively etched relative to the solidified polymeric material 750. As a result, a relief image is formed in the transfer layer 720. In these processes, the materials suitable for molds, substrates and photo-sensitive polymers are limited. Besides, one of the mold or the substrate must be transparent and thermal-resistant. In addition, etching step requirement also increases the complexity of the process.

A polymer bonding process for nanolithography was disclosed in Borzenko et al. (2001) Applied Physics Letters, 79 (14): 2246˜2248, wherein a PMMA film was first coated on the mold, and then transferred to a PMMA coated substrate. Nevertheless, it also needed a thermal treatment with a temperature above the glass transition temperature, which led to the thermal expansion of the mold and needed a long period of time to cool down. Also, the final etching step increased the complexity of the process.

Therefore, it is desirable to provide an improved method and apparatus for bonding lithographic imprint to a substrate to mitigate and obviate the aforementioned problems. A method and apparatus for bonding lithographic imprint by adhering means is disclosed as following.

### SUMMARY OF THE INVENTION

The object of the present invention is to provide a method and apparatus for bonding and transferring lithographic imprint to a substrate by adhering means, for achieving nanoscale (<100 nm) feature imprint transferring, , avoiding adverse effect on the precision of the line width caused by thermal expansion of the mold or substrate, and increasing the precision of the transferred imprints on the chips.

The other object of the present invention is to provide a method and apparatus for bonding and transferring lithographic imprint by adhering means, to increase the variety of source of imprint and bonding material, simplifying the formation of the patterned imprint in nanoscale without complicate etching process, and also reducing the cost of mass production.

To achieve the objects described above, the method for bonding patterned imprint by transferring, comprises the following steps: (a) providing a first module having a molding substrate, a molding layer and a patterned molding features, and a second module having a substrate; wherein said molding layer and said patterned molding features are located on said molding substrate; (b) coating a release layer on said molding features; (c) filling a transfer layer into the recess which is located between the patterned molding features; (d) coating an adhesion layer on said substrate of said second module; (e) contacting and bonding said second module and said first module together for transferring said transfer layer to said substrate of said second module without any rotation; and (f) separating said second module from said first module. These movements ensure the perfect parallelism between said first module and said second module.

To achieve the objects described above, the apparatus for bonding lithographic imprint by adhering means comprises a first holder for holding and carrying a first module having a mold substrate, a molding layer and a patterned transfer layer; a second holder for holding and carrying a second module having a substrate and an adhesion layer; an aligning unit positioned at one side of said second holder for moving and aligning said first holder or said second holder; at least one sensor for sensing and parallelizing the relative positions between said first module and said second module; and a controller for receiving electrical signals from said sensor, and for transmitting signals to said first holder or said second holder for aligning said two modules; wherein said sensor transmits electrical signals of the positions of said two holders to said controller, and then said controller controls the align unit electrically to align said first holder and said second holder horizontally and to move said first holder and said second holder vertically for combining said first module and said second module. These movements ensure the perfect parallelism between said first module and said second module.

In the present invention, the mold substrate can be any conventional substrates. Preferably, the mold substrate is silicon, glass, metal, ceramic or polymer substrates. The method for forming a transfer layer of the invention can be any conventional method. Preferably, the method for forming a transfer layer of the invention is spin coating, PVD—(Physical Vapor Deposition), CVD—(Chemical Vapor Deposition), plating, electroless plating, sol-gel process or FHD—(Flash Hydration Deposition).

The distance (D1), the width (W1), the length (L1) and the ratio (L1/W1) of recesses formed on transfer layer can be any size. Preferably, D1 ranges from 1 nm to 10 mm, W1 ranges from 1 nm to 11 mm, and L1/W1 ratio ranges from 0.1 to 10.

The selection of the material of transfer layer of the present invention is in coordination with the material of adhesion layer for achieving strong bonding between the transfer layer and the adhesion layer and facilitating releasing of the relief structure. Generally speaking, the bonding between the release layer and the transfer layer is weaker than that induced between the transfer layer and the adhesion layer. The material of transfer layer may be any one of conventional transfer layer material. Preferably, the transfer layer is semi-conductors, dielectric materials, high polymer materials, metal or combinations thereof. More preferably, when the transfer layer is made of polycarbonate (PC), polymethyl methacrylate (PMMA), polyimide (PI), Epoxy resin, UV curing gel or poly t-butylarcylate (PBA), then the material of adhesion layer is polycarbonate (PC), polymethyl methacrylate (PMMA), polyimide (PI), Epoxy resin, UV curing gel or poly t-butylarcylate (PBA) and the combinations thereof. Moreover, when the material of transfer layer is silver, lead-tin alloy, or other metal or ceramics, the material of adhesion layer is preferred to be gold, silver, lead-tin alloy, Epoxy resin, or UV curing gel, etc. Furthermore, tinsels (made with silver or aluminum, etc.) may be added into the polymer material to increase the electric and heat conductivities.

Transfer layer can be stick onto adhesion layer by contacting each other directly with suitable selection of both materials (i.e. transfer layer and adhesion layer). Besides, external force may be applied for bonding the modules by any conventional methods. Preferably, the external force is heat, pressure, exposure of laser pulses or ultraviolet, vacuum or ultrasonication. The external force can be determined based on the material chosen of transfer layer and adhesion layer. If both of transfer layer and adhesion layer are formed with PMMA, the method for bonding the transfer layer on the adhesion layer may be heating (at a temperature higher than Tg), pressurization (under a pressure about 5 MPa). In addition, exposure to laser pulses (e.g. KrF with wavelength of 248 mm or XeCl with wavelength of 308 mm for 20 ns duration,) for a very short period of time (about 200 ns) is another suitable option for the external force. In addition, if the adhesion layer is photo-sensitive polymer and the transfer layer is PMMA, the photo-sensitive polymer could be exposed to an ultraviolet light and then become adhesive with PMMA, i.e. the transfer layer. Moreover, if the transfer layer is made of lead-tin alloy and the adhesion layer is made of lead-tin alloy or gold, then ultra-sonication may be used for cold welding these two layers (i.e. the transfer layer and the adhesion layer). Some of the examples mentioned above are listed in table 1 below.

TABLE 1

| Materials of the | Matched materials of | |
|---|---|---|
| transfer layer | the adhesion layer | Adequate external force |
| Polymers | Non-photo-sensitive | Heat, pressure, vacuum, laser |
| | polymer | pulses |
| Polymers | Photo-sensitive | Ultraviolet |
| | polymer | |
| Metals | Lead-tin alloy, | Heat (thermal soldering), |
| | soldered tin, | ultrasonication, laser pulses |
| | photo-sensitive | (cold welding) |
| | polymer | |

Other objects, advantages, and novel features of the invention will become more apparent from the following detailed description when taken in conjunction with the accompanying drawings.

### BRIEF DESCRIPTION OF THE DRAWINGS

FIGS. 1(a)˜1(d) are cross-sectional views illustrating the process flow of Example 1 of the present invention;

FIGS. 2(a)˜2(d) are cross-sectional views illustrating the process flow Example 2 of the present invention;

FIGS. 3(a)˜3(d) are cross-sectional views illustrating the process flow of Example 3 of the present invention;

FIGS. 4(a)˜4(b) are cross-sectional views illustrating the process flow of Example 4 of the present invention;

FIG. 5 illustrates the apparatus for bonding lithographic imprints by adhering means of the present invention;

FIG. 6 is a flow chart illustrating the method for bonding patterned imprint by transferring of the present invention; and

FIGS. 7(a)˜7(e) are cross-sectional views illustrating the process flow of the prior art.

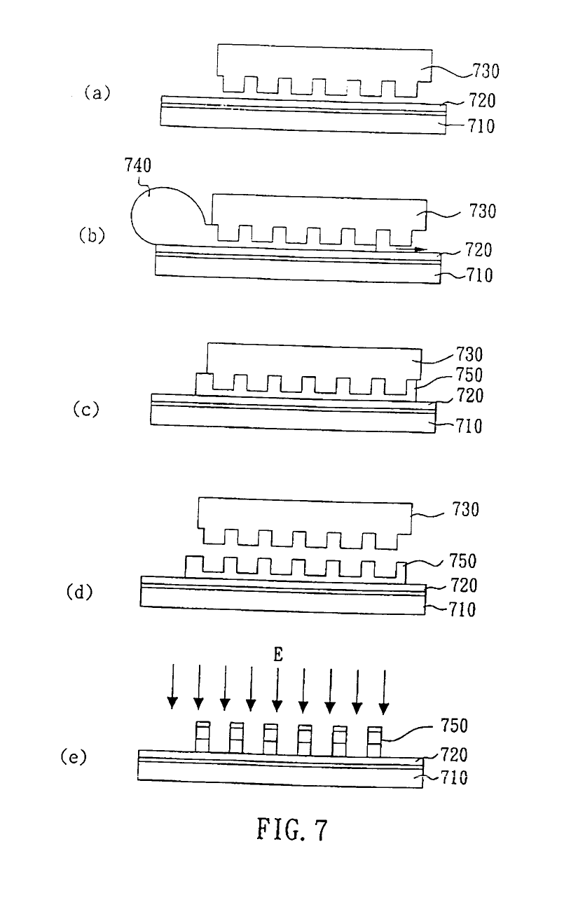

### DETAILED DESCRIPTION OF THE PREFERRED EMBODIMENT

### EXAMPLE 1

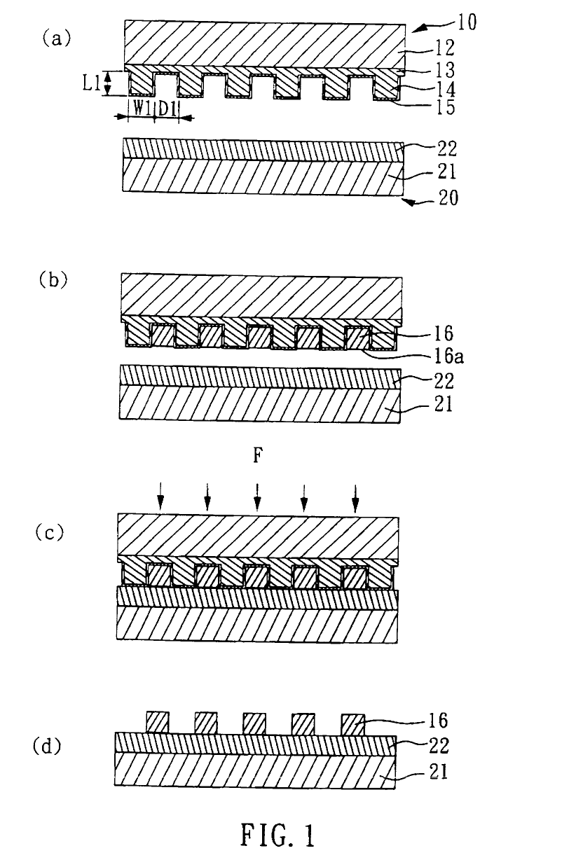

With referring to FIGS. 1(a)˜1(d), there are cross-sectional views for illustrating the process flow (of Example 1) of the present invention. As shown in FIGS. 1(a)˜1(d), a first module 10 having a molding substrate 12, a molding layer 13 and a patterned molding features 14 was first provided. The molding substrate 12 and the molding layer 13 of the present invention may be two independent layers or integrated into a unity. In the present example, the molding substrate 12 and the molding layer 13 were integrated into a unity. Then, the patterned molding features 14 were coated with a release layer 15. Besides, a second module 20 having a substrate 21 on which an adhesion layer 22 forms was also provided. Preferably, the material of the adhesion layer 22 was a photo-sensitive polymer.

With referring to FIG. 1(b), the material of transfer layer 16 was filled into the recess located between the patterned molding features 14. In the present example, the transfer layer 16 was preferred to be a PMMA layer, which had a pattern complementary to that of the molding features 14. After the molding features 14 and the substrate 21 had been aligned, the contact surface 16a of the PMMA transfer layer 16 of the first module 10 was combined and contacted with the photo-sensitive polymer adhesion layer 22 of the second module 20, as shown in FIG. 1(c). At this time, an external force F, which was preferred to be the ultraviolet irradiation was exerted to form a strong bonding between the PMMA transfer layer 16 and the photo-sensitive polymer adhesion layer 22. After the UV irradiation was stopped, the transfer layer 16 and the release layer 15 could be separated easily because the external force F induces a strong bonding force between the transfer layer 16 and the adhesion layer 22, which is larger than that between the transfer layer 16 and the release layer 15. In other words, the bonding between the release layer 15 and the transfer layer 16 is weaker than that induced between the transfer layer 16 and the adhesion layer 22. Thus, the second module 20 having the transfer layer 16 formed thereon is obtained, as shown in FIG. 1(d).

### EXAMPLE 2

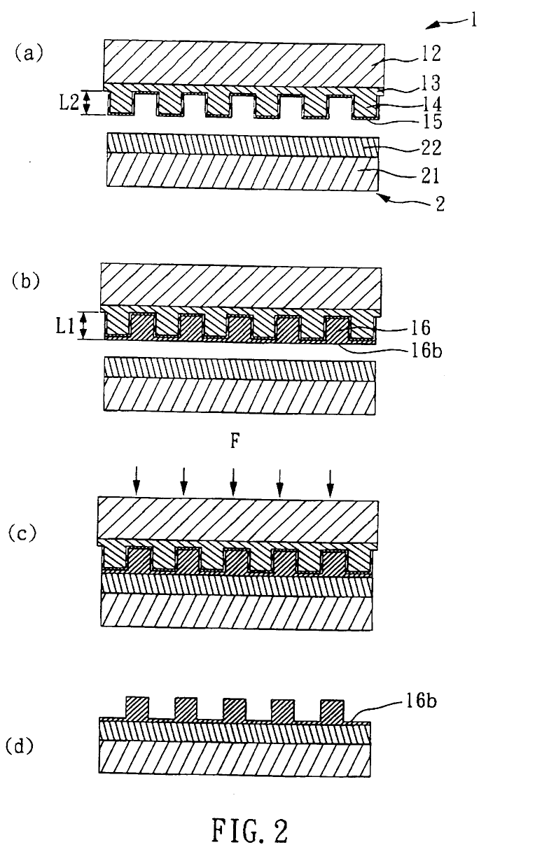

With reference to FIGS. 2(a)˜2(d), there are cross-sectional views for illustrating the process flow of Example 2 of the present invention. With Referring to FIGS. 2(a)˜(d), all the steps were very similar to that of Example 1, except that the depth L1 of the pattern formed on the transfer layer 16 could be larger than or equal to the depth L2 of the patterned molding features 14. When L1 was larger than L2, a continuous thin film 16b would form on the surface of the patterned molding features 14, as shown in FIG. 2(b). However, such a continuous thin film would not cause damages while being a bond between the transfer layer 16 and the adhesion layer 22. On the contrary, the continuous thin film 16b increased the bonding surface between the transfer layer 16 and the adhesion layer 22, which led to strong bonding there between.

### EXAMPLE 3

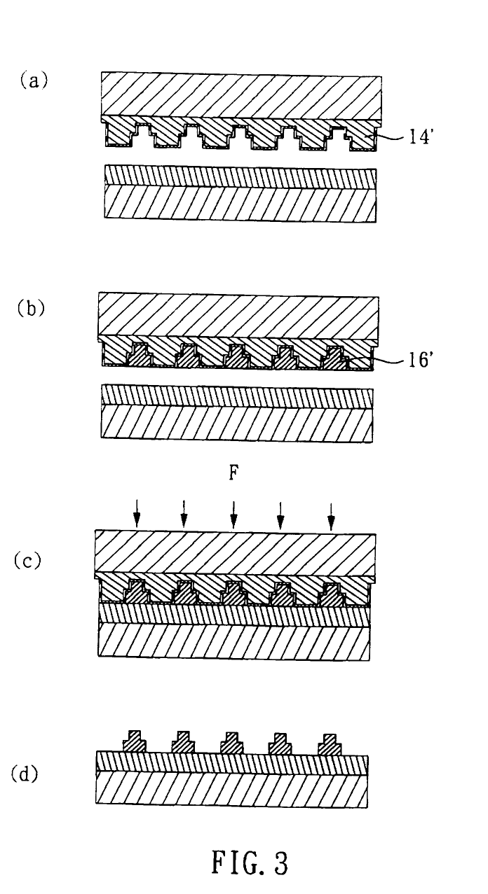

FIGS. 3(a)˜3(d) are cross-sectional views for illustrating the process flow of Example 3 of the present invention. With referring to FIG. 3(a)˜3(d), all the steps of Example 3 were very similar to that of Example 1, except that a transfer layer 16′ having an irregular cross-section was formed, which was formed through using a patterned molding feature 14 having an irregular cross-section. The irregular shape of the patterned molding features 14 would produce a complementary pattern in the recesses, which thus formed a transfer layer 16′ having an irregular cross-section. After the steps of the method of the present invention had been carried out, the irregular shape of the patterned molding feature 14 would be transferred to the transfer layer 16′ on the second module.

### EXAMPLE 4

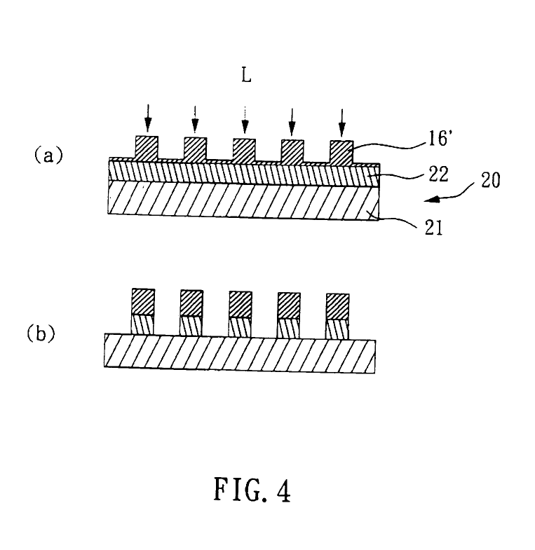

FIGS. 4(a)˜4(b) were cross-sectional views for illustrating the process flow of Example 4 of the present invention. FIG. 4(a) shows the cross-section of the second module 20 on which the transfer layer 16 is formed. The transfer layer 16 could act as a lithographic mask for carrying out dry or wet etching, through which the substrate was patterned, as shown in FIG. 4(b).

Furthermore, the transfer layer could be formed repeatedly at the same location on the substrate of the second module to produce a transfer layer composed of multi-laminates. Also, the transfer layer could be bonded onto the substrate step by step.

### EXAMPLE 5

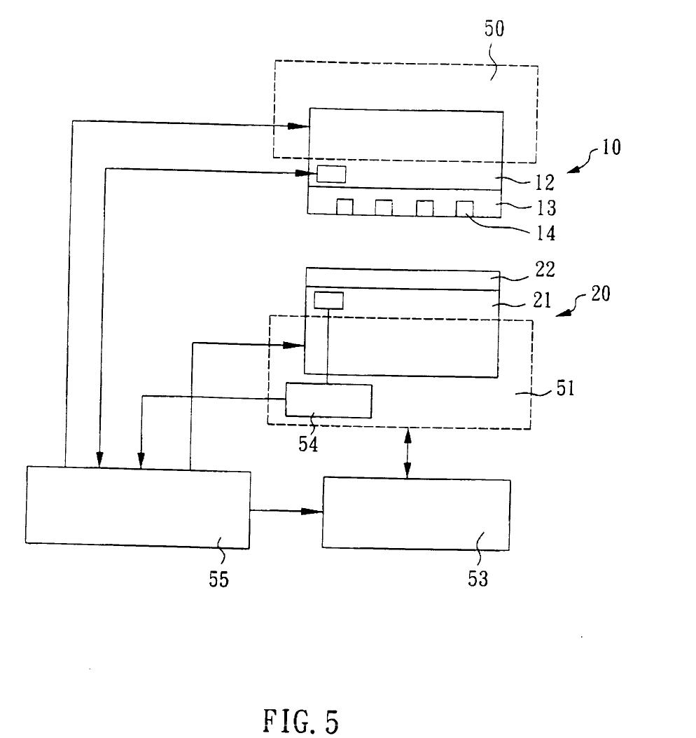

FIG. 5 illustrates the apparatus of the present invention, which comprised a first holder 50 for carrying the first module 10 having the molding substrate 12, the molding layer 13, the patterned molding features 14, and the transfer layer 16; a second holder 51 for carrying the second module 20 having the substrate 21 and the adhesion layer 22; an align unit 53 positioned at one side of the second holder 51 for removing the first holder 50 or the second holder 51 for aligning the first module 10 with the second module 20; an external force output unit (not shown) for enhancing the bonding force; at least one sensor 54 for sensing the relative position of the first module 10 and the second module 20; and a controller 55 for receiving the signals from the sensor 54 and then further outputting a removing signals to the first holder 50 or the second holder 51 in order to adjust or align the relative position of the two modules 10,20. After the horizontal position had been aligned, the first holder 50 are also arranged parallel to the second holder 51 in vertical position for subsequent process. The first holder 50 and the second holder 51 are then moved vertically for bonding the first module 10 and the second module 20 without rotation (neither horizontally nor vertically). These movements ensure the perfect parallelism between said first module and said second module.

### EXAMPLE 6

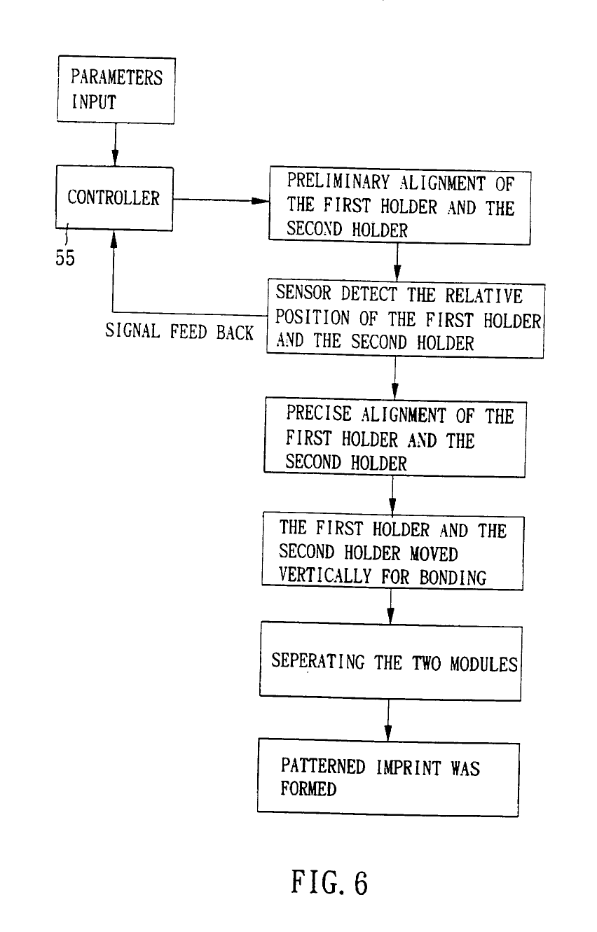

FIG. 6 is a flow chart illustrating the method for bonding patterned imprints by transferring of the present invention. First, the parameters were inputted into the controller 55, and then a preliminary alignment was carried out between the first holder 50 carrying the first module 10 and the second holder 51 carrying the second module 20 after the controller 55 had received the inputted signals. Afterwards, a sensor detected the relative position of the first holder 50 and the second holder 51, which was then feed-backed to the controller 55. After that, the controller 55 outputted a signal again to the align unit 53 for performing precise alignment. After the horizontal position had been aligned by the align unit 53, the first holder 50 and the second holder 51 were removed vertically for bonding the first module 10 and the second module 20. At the same time, another signal was transmitted to the external force output unit, which subsequently made the two modules bond with each other. Finally, the external force was released and removed vertically for separating the two modules, and the patterned imprint was formed on the second module 20.

The apparatus for bonding lithographic imprints by adhering means of the present invention can optionally further comprises a light source, a heater, an ultra-sonicator or a pressurization unit for exerting the external force and bonding the two modules. As a result, the pattern of the transfer layer of the first module is transferred to the adhesion layer of the second module.

Although the present invention has been explained in relation to its preferred embodiment, it is to be understood that many other possible modifications and variations can be made without departing from the spirit and scope of the invention as hereinafter claimed.

What is claimed is:

1. A method for bonding patterned imprint by transferring, comprising following steps:
(a) providing a first module having a molding substrate, a molding layer and a patterned molding features, and a second module having a substrate;
wherein said molding layer and said patterned molding features are located on said molding substrate;
(b) coating a release layer on said molding features;
(c) filling a transfer layer into the recess which is located between the patterned molding features;
(d) coating an adhesion layer on said substrate of said second module;
(e) contacting and bonding said second module and said first module together for transferring said transfer layer to said substrate of said second module; and
(f) separating said second module from said first module.

2. The method as claimed in claim 1, wherein said molding substrate is selected from the group consisting of silicon, glass, metal, ceramics, and polymer.

3. The method as claimed in claim 1, wherein the depth or the height of said recesses formed between said patterned molding features ranges from 1 nm to 10 mm.

4. The method as claimed in claim 1, wherein the width of said transfer layer formed between said recess ranges from 1 nm to 10 mm.

5. The method as claimed in claim 1, wherein the ratio of the depth to the width of said transfer layer ranges from 0.1 to 10.

6. The method as claimed in claim 1, wherein said transfer layer is formed through spin coating, physical vapor deposition (PVD), chemical vapor deposition (CVD), plating, electroless plating, sol-gel process and FHD.

7. The method as claimed in claim 1, wherein said transfer layer is selected from the group consisting of semi-conductors, dielectric materials, high polymer materials, metal and combinations thereof.

8. The method as claimed in claim 1, wherein the height of said transfer layer is larger or equal to the depth of said molding features.

9. The method as claimed in claim 1, wherein said step (e.) is performed by heating, pressurization, laser pulses, ultraviolet exposure, vacuum or ultrasonication, to bond said first module and said second module.

10. The method as claimed in claim 1, wherein bonding said transfer layer of said first module to said substrate of said second module is performed by direct contact.

11. The method as claimed in claim 1, wherein said transfer layer is made of multi-laminates.

12. The method as claimed in claim 11, wherein said multi-laminates is produced through forming said transfer layer on said substrate of said second module repeatedly at the same location.

13. The method as claimed in claim 1, wherein said transfer layer is bonded to said substrate step by step.

14. The method as claimed in claim 1, wherein said step (e) further comprises an alignment step between said patterned molding features and said substrate before performing step (e).

15. The method as claimed in claim 1, wherein said molding layer and said mold substrate is integrated into a unity.

16. The method as claimed in claim 1 is further comprising a step (g) using said transfer layer as a lithographic mask to transfer the pattern of said transfer layer to said substrate by etching.

17. The method as claimed in claim 16, wherein said etching method is dry etching or wet etching.

18. An apparatus for bonding lithographic imprints by adhering means comprising:
a first holder for holding and carrying a first module having a mold substrate, a molding layer and a patterned transfer layer;
a second holder for holding and carrying a second module having a substrate and an adhesion layer;
an aligning unit positioned at one side of said second holder for moving and aligning said first holder or said second holder;
at least one sensor for sensing and parallelizing the relative positions between said first module and said second module; and
a controller for receiving electrical signals from said sensor, and for transmitting signals to said first holder or said second holder for aligning said two modules;
wherein said sensor transmits electrical signals of the positions of said two holders to said controller, and then said controller controls the align unit electrically to align said first holder and said second holder horizontally and to move said first holder and said second holder vertically for combining said first module and said second module.

19. The apparatus as claimed in claim 18 further comprising a light source, a heater, an ultrasonicator, or a pressure head for bonding said transfer layer on said second module.
